(19) United States
(12) Patent Application Publication
(10) Pub. No.: US 2011/0146123 A1
(43) Pub. Date: Jun. 23, 2011

(54) Advertising System and Method and Display Tag Arrangement for Use Therewith

(75) Inventors: Josh DUNN, Los Angeles, CA (US); Caradoc EHRENHALT, Los Angeles, CA (US); Keith HEIMBOLD, San Diego, CA (US); Kim MACAULAY, Malibu, CA (US); Alexandra BROWNFIELD, Venice, CA (US); Tom UPSHUR, Boothwyn, PA (US)

(73) Assignee: AVERY DENNISON CORPORATION, Pasadena, CA (US)

(21) Appl. No.: 13/017,187

(22) Filed: Jan. 31, 2011

Related U.S. Application Data
(62) Division of application No. 12/642,918, filed on Dec. 21, 2009.

(51) Int. Cl. H04Q 5/22; G09F 3/00; G09F 3/02; G09F 3/10; G09F 3/14

(52) U.S. Cl. 40/638; 40/299.01; 40/674; 340/10.1

(57) ABSTRACT

A product announcement and merchandizing device and system is provided and includes a system and method for matching or merging a first product with one or more distinct products or services and displaying that merged message through use of a hang tag or an article identifier arrangement. The hang tag or article identifier has first and second sections with one or more individually operable and distinct fields. The system can actuate a message or other response in connection with receiving a particular signal or as part of an advertising campaign.

### CROSS-REFERENCE TO RELATED APPLICATION

The present application is a division of U.S. patent application Ser. No. 12/642,918 filed Dec. 21, 2009, which is incorporated herein by reference in its entirety.

### FIELD OF THE INVENTION

This invention is in the field of merchandising and advertising that utilizes display tags, and more specifically to a system for providing advertising and/or promotional offerings in connection with the use of display or hang tags and to co-promote one or more linked offerings through an on-line system.

### BACKGROUND OF THE INVENTION

Advertising of products and services is a major force in the world of business. For instance fragrance companies spend millions of dollars a year on advertisements, for example magazine advertisements, in order to expose a consumer to a new fragrance. In addition various retailers engage in significant print based marketing campaigns in order to draw awareness to other products or services being offered by the retailer or manufacturer.

New creative methods and venues for delivering advertising content to consumers are constantly being sought by retailers and those that provide the services to such outlets. An especially desirable feature for advertising venues is the ability to deliver targeted advertising to particular demographic groups. Another desirable feature is minimizing waste, and reducing cost and expense by utilizing existing carriers for the advertising message (e.g. the side of a bus) rather than dedicated carriers (e.g. a page in a newspaper, a roadside billboard, etc.). Additionally, the most desirable times for a consumer to be exposed to an advertisement are when the consumer is in a store or when the consumer is excited about receiving another product and the emotional interaction with a particular designer is elevated. Companies seek a mode of advertisement that would allow them to interact with the consumer at these crucial times.

Companies have heretofore attempted co-branding, where one manufacturer of a product will offer or advertise a related product. For example, such practices are currently seen in grocery stores, where a promotion on a gallon of milk may include a discount off the purchase of cookies. However, such co-branding attempts have been relatively limited to manufacturers that find themselves in a similar retailing space. Much of the co-branding initiatives are facilitated by personal and business relationships such as through advertising agencies and media buyers that attempt to broker arrangements between brand owners.

Most sellers utilize printed merchandizing tags to illustrate or convey basic information related to a product like the price or size of an item. The retailer is constantly being challenged to develop new methods to optimize the use of these merchandizing tags to further impact consumers in the retail environment.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In a first embodiment disclosed herein, a method comprises, providing a first product and announcing a first product to a pool of prospective customers; receiving a message not related to the first product in response to the first product announcement; and providing an article identifying the first product and including information regarding the message. The message relates to at least a second product which is demographically connected to the first product, although more than two products or services can be provided along with the first product.

In another embodiment disclosed herein, a system comprises a server connected to a computer network and hosting a website configured to receive announcements regarding products or services from a plurality of first parties or subscribers to the service. The system displays the received announcements and then waits to receive a response from at least one of a plurality of subscribers that is not the original party making the announcement. The second party issues a reply to a selected displayed announcement which is matched to the first product in at least one of a select number of categories, including demographics, merchandizing codes or channels, the received response includes information regarding a message not related to the first product announced in the selected announcement and to forward the response received from the second party. The system further includes an article manufacturer that is configured to receive the second party response from the server and to generate an article identifying the product and including information regarding the message. The system can be preprogrammed to release certain messages in accordance with contractual or other commitments or can be driven by demographics or time of day triggers.

Once selected, the messages or announcements can be merged and combined into one or more merchandizing platforms such as an apparel tag or other label or indicators. The merged merchandizing platform can be issued in a proof arrangement such that each of the participants in the system will have an opportunity to review and to comment on the appearance of the platform.

In a further exemplary embodiment of the presently described invention, a dual function apparel hang tag, is provided and includes a facestock that has first and second surfaces. The first section is provided adjacent one end of the facestock, and the first section having human and machine readable indicia relating to a first product. A second section separate from the first section has a plurality of distinct fields, with each of the distinct fields having unique advertising relating to more than one distinct products or services which is not the first product. The at least one of the fields includes graphical information and another of said fields includes at least one of tactile information, olfactory information, auditory information, and gustatory information. There may be two, three, four or more product offerings that are linked to the particular first product.

The tag and system may utilize a radio frequency identification (“RFID”) device to transmit and receive messages. The RFID may also be encoded with information. The RFID device can include information relating to the first and second products or services and may be used to activate one or more of the fields to generate a related advertising message on a second product that is related to the first product.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a front view of a hang tag article in accordance with the present disclosure;

FIG. 2 is a diagram of a marketplace in accordance with the present disclosure; and

FIG. 3 is a diagram of a computer implemented marketplace as shown in FIG. 2.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

In its simplest form, the present disclosure provides a new advertising venue by placing advertising information onto labels or other identifiers (also typically known as display or hang tags) that are affixed or otherwise connected to products or services that are being offered for sale. With respect to services, the labels or identifiers could be part of a direct mail campaign, be distributed as flyers or pamphlets, brochures or other printed information. The invention may also be considered rendered as a dual-functionality price tag. It should be understood that the present disclosure contemplates any and all manner of such labels, identifiers or tags that may be attached to or otherwise associated with a product offered for sale, including labels, hang tags, pocket flashers, leg stickers, etc. Such hang tags, as well known, usually carry information related to the product to which they are affixed, such as product name, stock number, manufacturer, price, ingredients, size, etc. and may also include graphic elements.

The term “hang tag” as used herein also includes other forms of soft-line and hard-line printed packaging in additional to conventional hang tag configurations. The printed advertisements could be applied to paperboard, cardboard, card stock, films, whether plastic or metal, recycled materials either alone or in combination with virgin material content, and the printed material could be applied directly to packaging materials such as plastic or polybags that are used in hold articles or goods for retail sale, as well as sewn in labels such as with a mattress or furniture cushions and articles of apparel. Thus the invention should not be limited or construed as to only hang tag configurations, but rather the invention should encompass other packaging.

The term attaching or connecting as used herein can refer to physically attaching or connecting the advertising article to the item of manufacture, enclosing or packaging the item of manufacture with the advertising article or otherwise associating the advertising article with the item of manufacture.

The present disclosure contemplates the placement of an advertising message on at least a portion of such a hang tag that is related to a service, or a good that is not the first or original product to which the hang tag is affixed, or any other promotional or marketing message. This will expose a potential buyer of the product or a shopper merely browsing and contemplating the product to be exposed to the advertising message for another product or service. This would induce the consumer to purchase more products or services significantly benefiting the seller, as the consumer may not have previously contemplated the additional products or services or the specific tie in arrangement that is being displayed by the merchandizing platform.

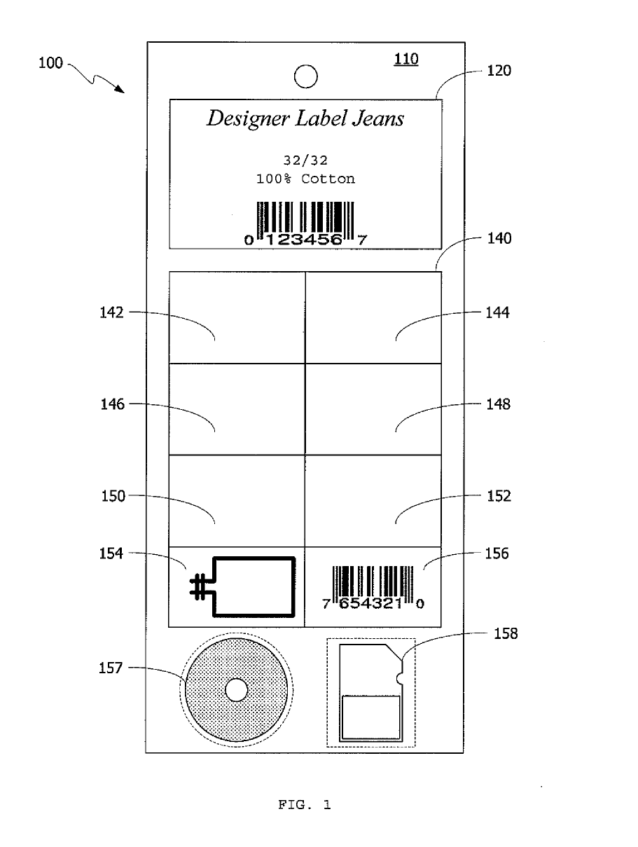

Referring to FIG. 1, an exemplary hang tag 100 may include a substrate or facestock 110 with a front and back face with the ability to attach the hang tag 100 to a product. The attachment feature may include a hole 112 formed therein for accepting a securing thread, or alternatively an adhesive portion or a clip or any other practicable attachment device, none of which are particularly relevant to the invention, unless the attachment feature represents a portion of the trade dress or other feature applicable to the retailer or manufacturer. The facestock or substrate 110 can be made from materials ranging from paper to plastic as well as recycled or reclaimed materials, such as reclaimed or recycled cellulosic materials, plastic bottles (PET) or other suitable material. The facestock or substrate can contain pure virgin materials, a 100% recycled materials or a portion of post consumer waste and virgin materials.

The tag 100 will typically include a portion 120 with information related to the product to which the tag is to be attached, as discussed above. That information may comprise text as well as graphics (human and machine readable indicia), such as trademarks, logos and bar codes or other product symbols such as care instructions. Additionally the tag may include a longitudinally extending perforated portion that allows for the advertising portion or the second section of the tag to be separated from the remainder of the tag. Additionally, the tag may comprise multiple portions with product information, such as on both sides of the tag, or in various areas of the same side of the tag. The printing or advertising components may appear on one side or both sides of the hang or display tag.

The tag is generally defined by first and second sections, with the first section designated by the human and machine readable indicia designated by reference numeral 120 and the second section 140 having a plurality of discrete fields (142, 144, 146, 148, 150, 152, 154, 156) that may contain unique advertising relating to one or more products or services that are not the first product. Certain of or all of the discrete fields can be concealed or covered by an actuating device, for example field 142, 144, 146, 148, 150 and 152 do not display the advertising message while other of the fields 145 and 156 have been exposed or actuated as they are now visible in the Figure. The concealing or actuating device can be a covering such as a removable label, or a coating that can be scratched off or otherwise removed by abrasive action. The actuation may also occur such as be electrical signal such as might be received by the RFID device which may be connected by a circuit to one of the fields to trigger for example an audible message that is currently concealed or create some visual or olfactory change, such as change in color or release of a fragrance or scent.

The first and second sections are separated from one another by a space, perforation line, score line or the like. The first section 120 can be provided with an attachment feature to hold the tag to a product and the attachment feature can include a string, hold, hook, adhesive or the like.

Any tag can be utilized within the embodiments disclosed herein, including substantially planar tags and three-dimensional tags. The non-limiting exemplary embodiment of FIG. 1 is shown with a typical planar, rectangular configuration for discussion purposes only and should not be construed as in any way limiting the invention.

The tag disclosed in the present invention is not limited to exhibiting price. For instance, the tag 100 may be further formed with at least one more portions 140 containing an advertising or merchandizing message related to a product or service other than the product to which the tag is attached. The advertising message may include any one or more of known advertising media, including text information 142, graphic information 144, tactile information 144, audio information 148, gustatory information 150, and olfactory information 152. Text information can be used on clothing, as a package insert, as a care label, and/or as instructions. Graphic information 144 may include trademarks, trade symbols, bar codes, etc. Tactile information 144 may include Braille coded messages, surface textures, etc. Audio information 148 may be provided in the form of an electronic circuit incorporated into the tag that may play a short message when activated. Activation can be triggered by touch or sound. Gustatory information 150 may be provided in the form of a strip or patch. Within the strip or patch may be a food product thereon to allow a user to lick the strip and thereby experience the flavor of the food product, and will preferably be covered by a protective layer to prevent environmental contamination and degradation. Olfactory information 152 may likewise be provided by a strip or patch with a scented product deposited therein that may release scent upon activation by rubbing, removal of an overlying protective layer, heat, light, moisture, etc. Alternatively, the tag may be provided with a container such as a pouch, capsule, canister, etc., that may contain a quantity of a food or other ingestible product, a product for topical application such as a cream, or a scented product, in solid (including powder), liquid (including creams and gels), or gaseous form.

The advertising message may further contain information digitally encoded in a RFID circuit as well known in the art. Suitable RFID circuits are described, inter alia, in commonly owned U.S. Pat. Nos. 7,170,415 and 7,477,151, the disclosures of both of which are incorporated herein in their entirety by reference thereto.

Typical radio frequency identification (RFID) tags or integrated circuits include a microprocessor, also known as a microchip, electrically connected to an antenna. Alternatively, the microchip is first attached to a pad having electrical leads that provides a larger attachment of “landing” area. This is typically referred to as a “strap” or “interposer.” The strap is then attached to the antenna.

The microprocessor stores data, which can include identifying data unique to a specific item, which is transmitted to an external receiver for reading by an operator and processing of the item. RFID tags can be attached to items for inventory control, shipment control, and the like. RFID tags are particularly useful in identifying, tracking and controlling items such as packages, pallets, and other product containers. The location of each item can be tracked and information identifying the owner of the item or specific handling requirements can be encoded into the RFID and later read by a scanning device capable of decoding and displaying the information.

Digitally encoded information may be further provided in any other digital media, including but not limited to compacts discs or mini-CDs 157, DVDs, flash memory cards 158 such as SD and CompactFlash cards, etc. Such digital media could be attached to the tag 100 such as by adhesive or other means or incorporated within it such as for tearing away, as depicted in the embodiment of FIG. 1. In addition, segment 157 may also provide an auditory mechanism, to play a recorded message when the segment 157 is actuated.

The tag 100 may include a plurality of portions containing an advertising message, and may contain a plurality of advertising messages that may be directed to the same or to different goods and services. It should be understood that the advertising message placed on a hang tag in accordance with the present disclosure is not limited to commercial speech, and in fact can comprise any message that any entity may desire to disseminate. As such, the advertising message may contain religious messages, political messages, government messages, legal messages, etc.

Thus, in accordance with the present disclosure as provided in FIG. 1, the tags that currently accompany many of the products or services sold at retail (most typically clothing and fashion accessories such as handbags, belts, hats, scarves, hosiery, etc.) may include an advertising message on portions thereof. Thus the present invention may be utilized for brand association in which specific advertising is paired with the product to which the tag is attached so as to target consumers with similar taste. For instance, a tag attached to a leather jacket may carry an advertising message ranging from a motorcycle manufacturer or a motorcycle dealer, to leather care products or services, to other fashion accessories that may be of interest, such as protective gear like helmets, pads or accessories for the motorcycle. Likewise the advertising may also suggest particular resort locations that cater to motorcycle enthusiasts, social networking clubs and the like.

In this manner, more than one product or service can be offered along with the original product offering thereby providing an efficient medium by which to reach a targeted customer. A challenge for implementing the novel advertising venue described herein is to provide a matching arrangement between the product or service to which the tag is attached or associated that is not specifically advertised on the tag with products or services that are in fact advertised upon the product's tag that may be relevant to a consumer of the product. In accordance with the present disclosure, a novel method is provided to address this challenge.

While FIG. 1 has been depicted as a hang tag, it should be understood, that instead of a hang tag, soft or hard packaging could be used such as printed packaging that may include a plastic or film based bag that may be used for example in the packaging of apparel accessories, or with garments such as socks or gloves.

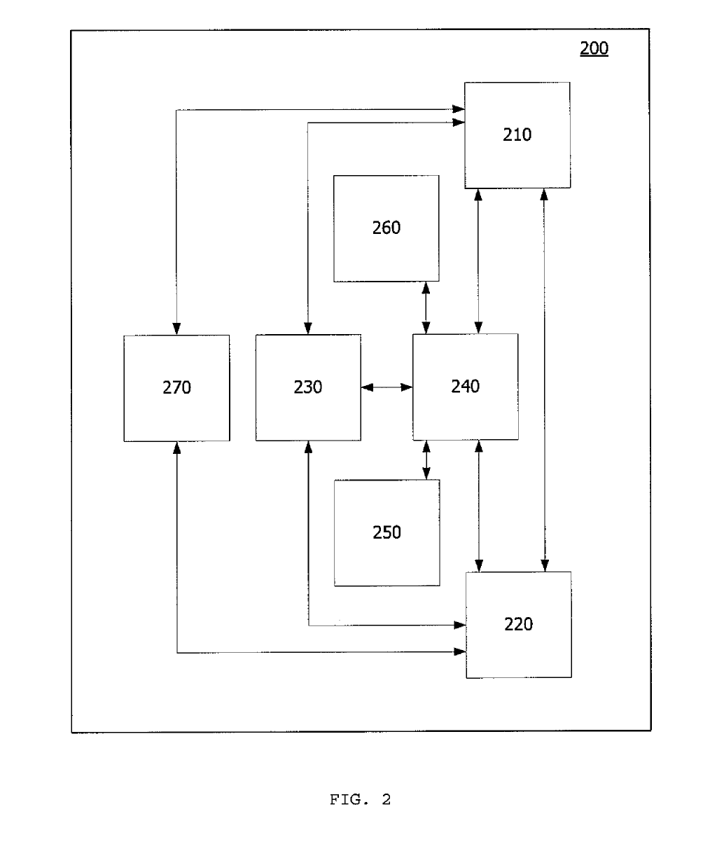

With reference now to FIG. 2, in an embodiment in accordance with the present disclosure, a schematic of an on-line marketplace 200 is provided wherein the various entities that need to participate to providing an advertising hang tag as disclosed above can effectively and efficiently interact and cooperate. These entities may include, inter alia, manufacturers 210 of products or services for sale who are willing to allow advertising to be placed onto hang tags attached to their products or services, and providers 220 of products or services who desire to advertise their respective products or services on hang tags attached to products or services on sale (i.e. the advertisers). Further entities that may participate in the marketplace 200 according to the present disclosure include providers 230 of the hang or display tags, that may have unique merchandizing platforms but which to highlight a particular good or service, advertising agencies 240 acting on behalf of the product manufacturers 210 or the advertisers 220, providers 250 of advertising content (e.g. artists), market research firms 260, and retail outlets 270. These are intended to be exemplary participants in this arrangement and the selection or combination should in no way be viewed as limiting the scope or disclosure of the invention.

In accordance with one embodiment disclosed herein, in an exemplary arrangement, the marketplace 200 would operate to allow a plurality of manufacturers 210 and advertisers (be they the actual manufacturers or provider 220 of an advertised product or service, or advertising agencies 240) to identify each other and enter into an agreement to advertise the one's product or service onto the other's product for sale. One such embodiment entails an auction-type marketplace wherein manufacturers 210 can announce or advertise the availability of promotional or marketing space on the hang tags of their products or services for sale. Advertisers or retailers 220, 240 can then contact a manufacturer 210 of interest (that is, who has a product for sale that is of interest to the advertiser) and seek to enter into an agreement to place the former's advertising message onto the latter's product for sale hang tag. Alternatively, the marketplace may operate like a true auction, wherein if a plurality of advertisers are interested in placing their promotional or marketing messages onto the same hang tags of a particular product for sale, such as a “hot” apparel item with limited release, or a particular fashion designer, they may each submit bids and the product manufacturer 210 may then select a winning bid based on any criteria the manufacturer may desire to apply. Ideally the product manufacturers 210 will have control over the selection process or final approval of the promotional or marketing message to be placed onto their product's hang tag, so as to assure that the product manufacturer agrees to pair its product for sale with the advertiser's promotional or marketing message. Alternatively, contractual arrangements can be entered into between retailers, advertisers and manufacturers to develop a marketing campaign.

Once an agreement has been reached through the market place schematic provided in FIG. 2, a proof of the hang tag may be generated to allow both the first party, the one offering the original product, and the second party, the one bidding or wanting to display a message in cooperation with the first product, to see a pre-production sample of the hang tag. Either of the parties may then propose changes to the hang tag, such as colors, font or text arrangements, graphics or the like before agreeing to release a final proof for production and attachment to the particular tag or service of interest.

By aggregating a plurality of manufacturers 210 and advertisers 220 in a convenient space, the marketplace 200 of the present disclosure creates an efficient system for advertisers to identify available promotional or marketing hang tag space on the most desirable product(s) for sale in view of the advertised good or service. Furthermore, by participating in a marketplace as disclosed herein, an advertiser can further target a particular group of consumers or individuals in a particular demographic who will be exposed to the advertising message not just by selecting specific products or services onto whose hang tags the advertising message will be displayed, but also selecting the geographical areas in which the product will be sold. This may be implemented in various manners, non-limiting examples of which include packaging and shipping of the product with the appropriate advertising message to the selected geographical area by the product manufacturer, or including the retail outlets 270 in the manufacturer/advertiser agreement so that the advertiser can be select specific retail outlets to receive products or services with hang tags bearing specific advertising messages. For instance, a motorcycle dealer could thus select retail outlets within 100 miles of the dealer's location to place an advertising message promoting the dealership on leather jackets from a specific leather jacket manufacturer and being sold by the selected retail outlets or a particular motorcycle vacation or resort that one may wish to visit.

In another embodiment, by participating in a marketplace as disclosed herein, an advertiser can further target the period of time during which consumers who will be exposed to the advertising message, that is the duration that the marketing or advertising campaign may run. This may be implemented by manufacturers announcing in the marketplace products or services for sale that have limited shelf life, such as food or beverages, off season vacation specials, retail outlet grand openings, etc. and offering promotional or marketing space on hang tags for specific lots of such products or services having specific expiration dates and optionally specific shipping dates. An advertiser could then select a product having a specific shelf life or offer expiration date for including a specific, time-sensitive advertising message—such as a promotion for a new movie.

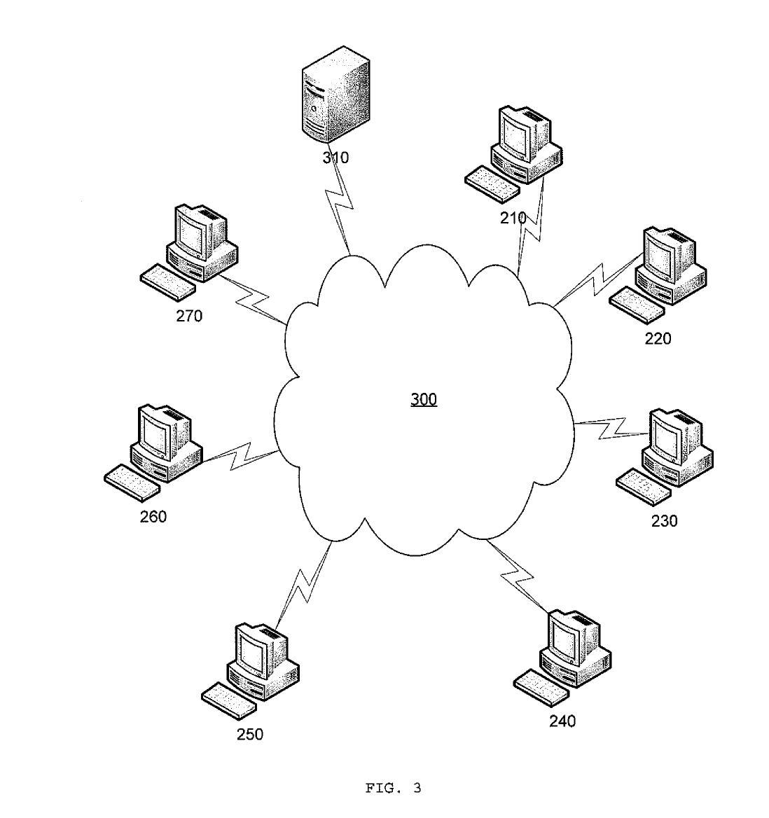

The marketplace 200 may be a computer-based solution, wherein the various entities communicate through a computer network 300. In one particular, non-limiting, exemplary embodiment depicted schematically in FIG. 3, the marketplace 200 of the present disclosure is an Internet-based solution effectuated through an Internet web site hosted on a server 310 that allows the various entities to interact as described herein. The server hosting the web site 310 may be under the control of any of the entities participating in the marketplace, and in one particular embodiment the marketplace may be administered by the hang tag provider, an advertiser or manufacturer. The party administering the marketplace may charge a fee to the other entities participating in the marketplace or subscribing to the service, or may derive some other commercial benefit. In this embodiment the advertiser could also deliver the advertising or marketing message to the product manufacturer or alternatively deliver it directly to the hang tag manufacturer 230, optionally subject to the product manufacturer's approval.

Participation in a marketplace 200 as described herein, particularly a computer network-implemented marketplace, can further streamline the process of delivering advertising messages on product hang tags by enabling a retail-like experience for the advertisers, wherein selecting a hang tag or winning a bid for a hang tag would automatically give effect to pre-arranged contract terms that all parties have pre-agreed to be bound by—thereby essentially providing a point-and-click experience as is typical of shopping on the Internet.

In other embodiments, further entities as mentioned previously may participate in the marketplace 200 of the present disclosure. For convenience, similar reference numbers used in FIG. 2 are also used in FIG. 3. Thus, advertising agencies 240 acting on the behalf of manufacturers 210 of products or providers of services for sale may announce the availability of promotional or marketing hang tag space, and also enter into agreements with advertisers for placing advertising messages on hang tags. Advertising agencies 240 may also act on behalf of other advertisers and identify hang tag promotional or marketing space availability and attempt to broker that space for future use and also enter into agreements with the product manufacturers for placing advertising messages on their hang tags.

It should be understood that the term advertising message as used herein is not limited to commercial speech but is intended to encompass any and all types of information that an entity may wish to disseminate publicly regardless of potential financial gain and that is not related to the product to which the hang tag is attached.

The term “demographic” as used herein refers to one or more particular characteristics of a population such as age, sex, religion, ethnicity, style, size, geographic area, educational background and the like.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

What is claimed is:

1. A dual functional apparel hang tag, comprising;
a facestock having first and second surfaces;
a first section provided adjacent one end of the facestock, the first section having human and machine readable indicia relating to a first product;
a second section separate from the first section and having a plurality of distinct fields, with each of the distinct fields having unique advertising relating to more than one distinct products or services which is not the first product; and
wherein at least one of the fields includes graphical information and another of said fields includes at least one of tactile information, olfactory information, auditory information, and gustatory information.

2. A dual function apparel hang tag as recited in claim 1, wherein said another of said fields includes an RFID tag.

3. A dual function apparel hang tag as recited in claim 1, wherein the first and second sections are separated from one another by one of a transversely extending space, perforation line or score line.

4. A dual function apparel hang tag as recited in claim 1, wherein the first section includes an attachment feature for the first product.

5. A dual function apparel hang tag as recited in claim 4, wherein the attachment feature is selected from a group including a string, adhesive, hook or hole.

6. A dual function apparel hang tag as recited in claim 2, wherein the RFID tag is encoded with information related to the first product.

7. A dual function apparel hang tag as recited in claim 1, wherein the RFID tag activates the field for auditory information.

8. A dual function apparel hang tag as recited in claim 1, wherein the olfactory and gustatory information fields are activated by removing a coating.

9. A dual function apparel hang tag as recited in claim 1, wherein each of the other of said fields is provided with an activation device.

10. A dual function apparel hang tag as recited in claim 1, wherein the facestock is made from recycled materials.
